(19) United States
(12) Patent Application Publication
(10) Pub. No.: US 2015/0101248 A1
(43) Pub. Date: Apr. 16, 2015

(54) Mesh Lined Planter Box

(71) Applicant: Jacob C. Adkinson, Bellingham, WA (US)

(72) Inventor: Jacob C. Adkinson, Bellingham, WA (US)

(21) Appl. No.: 14/510,533

(22) Filed: Oct. 9, 2014

Related U.S. Application Data
(60) Provisional application No. 61/889,255, filed on Oct. 10, 2013.

(51) Int. Cl. A01G 9/02; A01G 27/00; A01G 9/12

(52) U.S. Cl. CPC A01G 9/02; A01G 9/12; A01G 27/008
USPC 47/70; 47/65.5; 47/79

(57) ABSTRACT

Disclosed herein is a mesh lined planter box for use in growing of plants where mobility and/or easy removal of the plants and/or growing media is desired. The mesh lining in one example comprises a replaceable fabric mesh bag into which growing media is placed for growing of plants. Also disclosed is a trellis which may be removed from the planter box. The trellis may also include vertically adjustable cross members. A watering system is also disclosed attached to the base unit, or trellis of the planter box. The watering system in one form comprising a plurality of feed lines attached to a common main line and having valves on each feed line.

### RELATED APPLICATIONS

This application claims priority benefit of U.S. Ser. No. 61/889,255, filed Oct. 10, 2013, incorporated herein by reference.

### BACKGROUND OF THE DISCLOSURE

### Field of the Disclosure

This application relates to the field of planter boxes having one or more of a removable liner, front panel, casters, attached trellis, and/or an attached watering system.

### BRIEF SUMMARY OF THE DISCLOSURE

Disclosed herein is a fabric mesh lined planter box comprising in one example: a plurality of wire mesh panels forming a base unit; a fabric mesh bag supported by the wire mesh panels; and the fabric mesh bag configured to contain growing media for growing of plants therein.

The planter box as recited above may be arranged wherein one of the wire mesh panels is a front wire mesh panel coupled to the base unit by way of at least one hinge so as to allow opening of the front wire mesh panel.

The planter box as recited in above may further comprise a watering system comprising a main line attached to the base unit and having a hose connection thereon.

The planter box as recited above may further comprise a drip pan for capture and/or re-diversion of water.

### BRIEF DESCRIPTION OF THE SEVERAL VIEWS OF THE DRAWINGS

FIG. 1 is a rear isometric view of one example of the disclosed apparatus.

FIG. 2 is a rear isometric view of the example shown in FIG. 1 with some components removed.

FIG. 3 is a front isometric view of the example shown in FIG. 1 with additional components removed from that shown in FIG. 2.

FIG. 4 is a front isometric view of the example shown in FIG. 3 with a front gate opened.

FIG. 5 is a front isometric view of the example shown in FIG. 4 with a mesh bag inserted therein.

FIG. 6 is a front isometric view of the mesh bag shown in FIG. 5.

FIG. 7 is a top isometric view of one example of the drip pan.

FIG. 8 is a top isometric view of the disclosed apparatus with a watering system.

FIG. 9 is a front isometric view of the apparatus as shown in FIG. 8 with the front panel opened.

FIG. 10 is a front isometric view of the apparatus as shown in FIG. 9 with the panel of the mesh bag cut and folded down.

FIG. 11 is a right end view thereof, with the right end view being a mirror image thereof.

FIG. 12 is a detail view of the region 12 of FIG. 11.

FIG. 13 is a top view thereof.

FIG. 14 is a rear view thereof.

FIG. 15 is a bottom view thereof.

FIG. 16 is a front view thereof.

FIG. 17 is a front isometric view of the overall apparatus.

### DETAILED DESCRIPTION OF THE DISCLOSURE

Disclosed herein is a mesh lined planter box for use in growing of plants where mobility and/or removal of the plants and/or growing media in which the plants are grown is desired. The mesh lining in one example comprises a replaceable fabric mesh bag into which growing media is placed for growing of plants. Also disclosed is a trellis which may be removed from the planter box. The trellis may include vertically adjustable cross members. A watering system is also disclosed as attached to the base unit or trellis of the planter box. The watering system in one form comprising a plurality of feed lines attached to a common main line and having valves on each feed line.

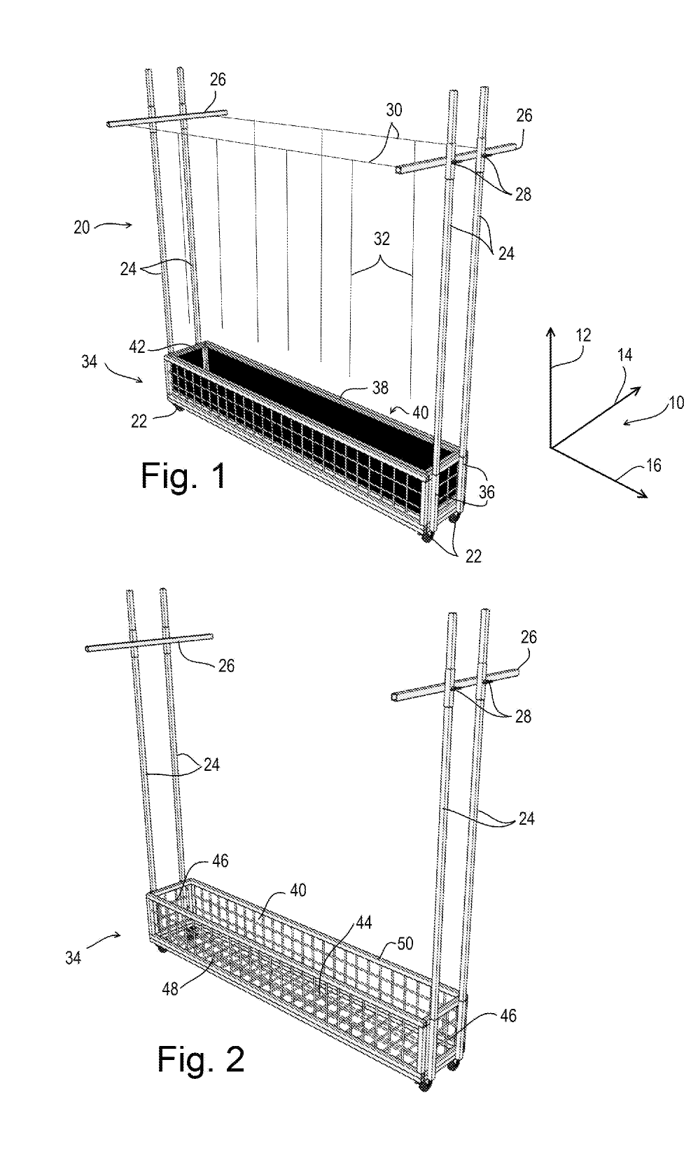

The apparatus in one example comprises several components which are removable or repositionable relative to each other to allow for modification and adjustability. Looking to FIG. 1 for example is a mesh lined planter box 20 optionally with wheels or casters 22 attached to the bottom thereof to allow the planter box to be moved without lifting, skidding, dragging, or other difficult and/or damaging repositioning methods. The planter box 20 as shown in this example also includes a plurality of trellis posts 24 at either longitudinal end thereof for attachment of a trellis. In this example, the trellis comprises a trellis cross member 26 is attached to the trellis posts 24 by way of a trellis adjuster 28 to allow for vertical repositioning of the trellis cross member 26 along the trellis posts 24. In one form, the trellis adjuster 28 comprises simple bolts which are threaded into threaded voids of the trellis cross member 26 to frictionally engage the outer surface of the trellis posts 24. Removable pins are another adjustment system as described below. In one example, the trellis also comprises longitudinal strings or wires 30 are tied or otherwise attached to the cross members 26. The trellis may also comprise vertical strings or wires 32 hanging therefrom so as to provide support for beans or other plants.

Before continuing a detailed description of the invention, an axes system 10 as shown in FIG. 1 is defined to aid in description. The axes system 10 comprises a vertical axis 12 generally aligned in the vertical direction wherein the arrow is shown pointing in an upwards direction. A transverse axis 14 is also shown in FIG. 1, with the arrow pointing in the front (forwards) direction. The front direction is arbitrary relative to the apparatus, and is selected here as the side of the apparatus which in some examples includes a hinged gate. A longitudinal axis 16 is also shown with the arrow pointing in a left direction relative to the front direction. The longitudinal axis 16 is perpendicular to each of the vertical 12 and transverse 14 axes. These axes are intended to aid in description of the invention and are not intended to limit the apparatus to a particular orientation.

The apparatus in FIG. 1 also comprises a base unit 34 or mesh box to which the trellis posts 24 and casters 22 are attached.

In one form a plurality of trellis posts receivers 36 are welded, riveted, bolted, or otherwise fastened to the base unit 34. In one form, the trellis posts receivers 36 having inner surface slightly smaller than the outer surface of the trellis posts 24 such that the trellis posts 24 can be slid into the trellis posts receivers 36 and held in place by way of gravity. This arrangement may also allow vertical positioning of the base unit to a desired vertical height. For example, in a nursery environment, it may be desired to have the upper edge 116 of the base unit substantially at waist height. A stop member may be provided at the bottom of the post receivers 36 or on the posts 24 to limit vertical movement of the trellis posts 24 within the receivers 36 or limit vertical movement of the base unit 34 along the trellis posts 24.

The base unit 34 in one form comprising a plurality of mesh panels 44, 46, 48, and 50 attached to a base unit frame 114. In one form the trellis post receivers 36 form part of the base unit frame 114 and the casters 22 are attached to the bottom end of the trellis posts 24. The base unit may be formed by attaching the frame and panel components by bolting, riveting, welding, brazing or any combination or equivalent method.

In the example of FIG. 1, a fabric mesh bag 38 is shown installed into the interior compartment 40. The fabric mesh bag 38 is porous to allow water there though, but substantially prohibit growing media 42 from passing there through. Once the fabric mesh bag 38 is in place and all components are fastened, the fabric mesh bag 38 may be filled with growing media 42 (growing media, peat, fertilizer, and equivalents) and plants or seeds positioned therein for growing.

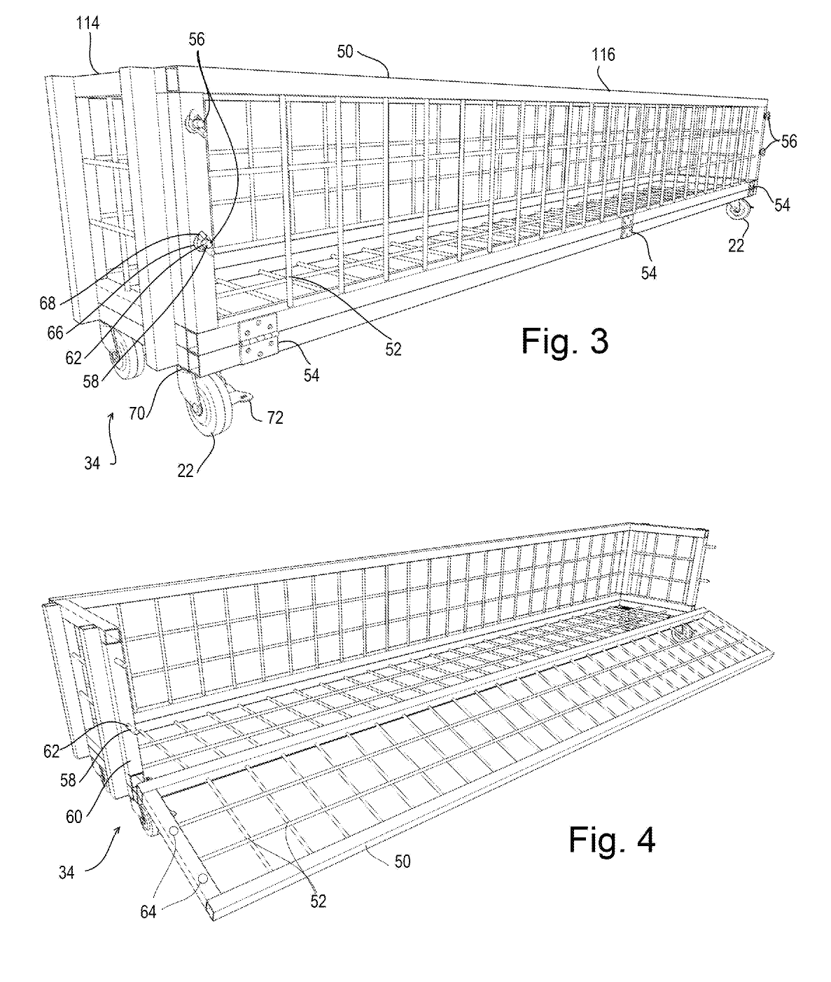

Testing has shown that a fabric mesh bag 38 is often not sufficient to support a quantity of growing media therein. Thus wire mesh or perforated panels may be utilized to support the mesh bag. For example, welded wire mesh commonly used for rabbit cages commonly has a mesh size of 1″×2″ using 14 gauge wire which is been found adequate to support a fabric mesh bag 38. For some applications, especially when cross-members 134 are provided in the bottom and/or sides of the base unit 34 to support the wire mesh. Wire meshes of other mesh sizes up to for example 4″×4″ using 6 mm or 8 mm wire have also been utilized. In many applications, it is desired to weld, twist, or otherwise affixed the contact points 52 (See FIG. 3/4) between crossing wires to further enhance stability of the wire mesh. In this application, the term wire mesh is used to differentiate from the tighter weave fabric mesh of the bag which is placed into the interior compartment 40. Generally speaking, the fabric mesh is a screen-like or burlap-like material. The fabric mesh is often woven or pressed such as in the use of porous landscape fabric and may be made of natural fibers or other biodegradable materials. The wire mesh will generally made of metals or more rigid materials such as steel, stainless steel, aluminum, brass, fiber reinforced plastic, plastic reinforced carbon fiber, etc. and will generally not be made of the biodegradable material.

The apparatus shown in FIG. 2 comprises a wire mesh bottom panel 44 generally attached to the base unit 34 along with wire mesh end panels 46 and a wire mesh back panel 48. A wire mesh front panel 50 may be utilized as well.

The front panel 50 may be attached in a different manner from the back panel 48 to facilitate removal of the plants when proper maturity has been achieved. In the example shown in FIGS. 3 and 4 for example, a plurality of hinges 54 may be used to as to allow the front panel 50 to fold down and open. This opening front panel 50 allows easy access to the interior compartment 40. The fabric mesh bag 38 is not shown in FIGS. 2-4 so as to more easily show the components there within.

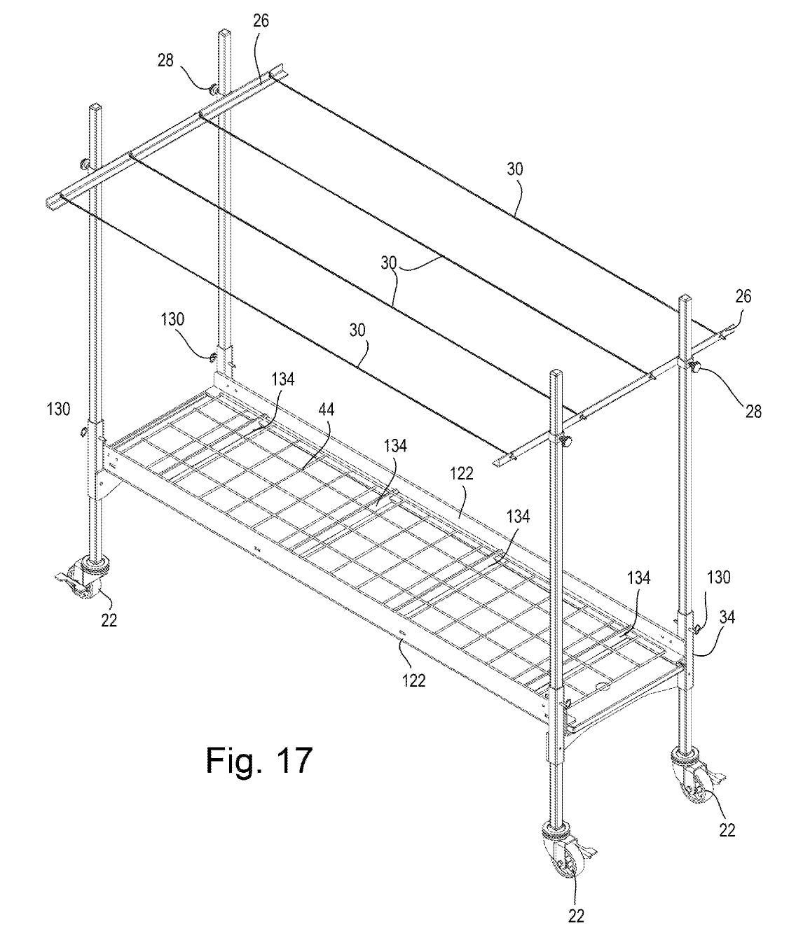

In the example shown in FIGS. 3 and 4, the front panel 50 and front frame are attached to the rest of the base unit 34 by way of the hinges 54 and also by way of a gate latch 56. In other examples, such as in FIG. 17, each of the bottom panel 44, end panels 46, back panel 40, and front panel 50 are rigidly attached to the base unit frame. In the example shown in FIGS. 3 and 4, the gate latch 56 comprises a plurality of bolts 58 which pass through a vertical member 60 of the base unit frame 114 and have a threaded portion 62 on the end thereof. Each threaded portion 62 passes through a surface defining a hole 64 in the front panel frame. A washer 66 and nut 68 such as a wing nut may be threaded onto the threaded portion 62 of the bolt 58 to hold the front panel 50 in position relative to the other components of the base unit 34 as the mesh bag is positioned therein along with growing media and plants. As shown, a gate latch 56 may be provided at both longitudinal ends of the front panel 50 and each gate latch 56 may include at each and a plurality of nut bolt washer combinations. Other gate latches may be utilized with equal effectiveness.

FIG. 3 also shows casters 22 comprising a pivot 70 to allow for rotation of the caster 22 in a horizontal plane so as to facilitate horizontal movement of the planter box 20 in different directions. To add security to the apparatus, a caster lock 72 may be added to one or more of the casters 22. Such caster locks 72 often prohibit rotation of the caster 22 in a vertical plane and/or prohibit pivoting of the caster 22 in a horizontal plane.

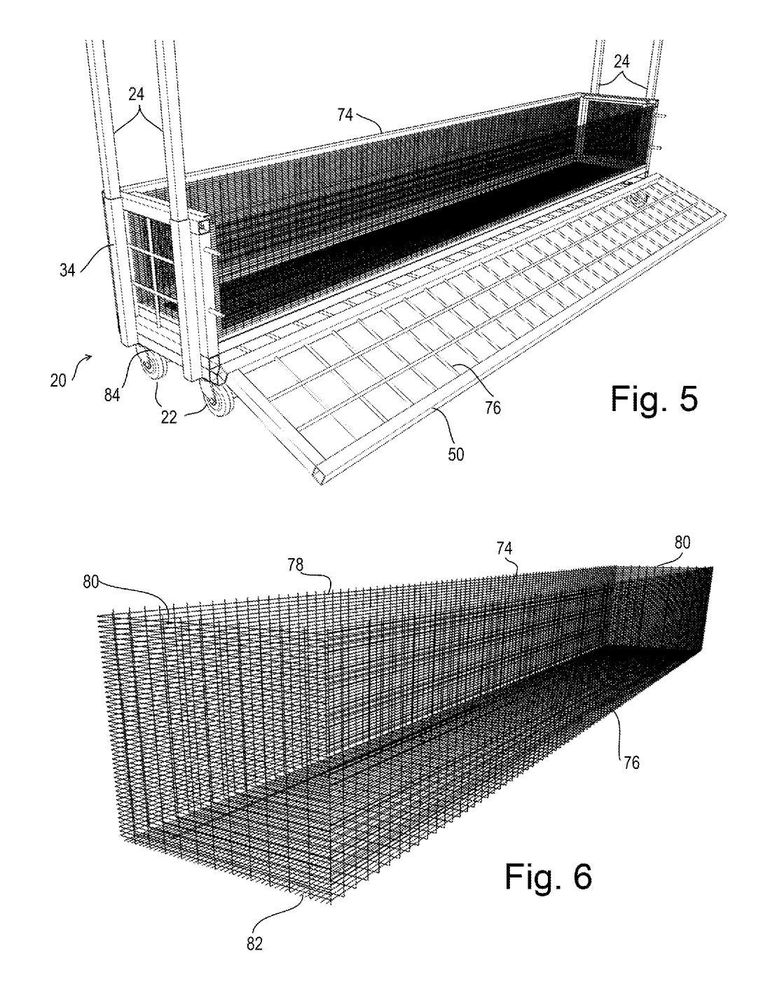

Looking to FIG. 5, the planter box 20 is shown with a fine screen mesh bag 74 positioned therein. The fine screen mesh bag is often of substantially finer mesh than the panels 44, 46, 48 and 50. In many examples the fine screen mesh bag is coarser (larger openings) than the fabric mesh bag 38. Although a single fine screen mesh bag 74 is used in this example, it is to be understood that multiple nesting fine screen mesh bags 74 could be utilized. It is also to be understood that the wire mesh 76 forming the panels of the base unit 35 is shown with a large spacing for ease in drawing and reproduction and these drawings are not necessarily to scale. In use, it may be beneficial to have a smaller spacing between the wires of the wire mesh than that shown, or add additional supports in each of the panels. In another example, a first wire mesh 76 has a first wire spacing and a second mesh 74 may be provided with a much smaller spacing and in contact with or attached to the first wire mesh 76. For example, the first wire mesh 76 may have a 4-inch spacing with 8 mm wire, while the second wire mesh 74 may have a 1 inch spacing with 14 gauge wire.

FIG. 6 shows an example where the fine screen mesh bag 74 has front and rear panels 76 and 78 respectively, left and right and panels 78 and 80 respectively and a bottom panel 82. The fine screen mesh bag 74 may be made of a screen material such as found in screen doors. This material is often made of metals including aluminum; or nylon or other natural or synthetic woven or pressed materials. Alternatively, woven or pressed fabrics may be utilized such as cotton cloth, bamboo cloth, burlap etc. It may be desired to have the fine screen mesh bag 74 made of a biodegradable material with a usable lifespan sufficient to allow growing of plants therein but decomposable over a longer period of time to reduce landfill and two allow the fine screen mesh bag 74 to be part of a replanting method wherein the plants and a portion of the fine screen mesh bag 74 are removed from the planter box 20 and installed in landscaping, a garden, etc. while still protected by the mesh bag material.

In one method, upon growth of the plants within the planter box 20 to desired maturity, the gate latch 56 is released, the front panel 50 repositioned to the orientation shown in FIG. 5. The fine screen mesh bag 74 may then be cut by a knife or scissors, torn on either longitudinal side of the plant or otherwise opened. When opened, the front panel of the fabric mesh bag may lay against the front panel as shown in FIG. 10. This method allows segmenting the fine screen mesh bag 74 in two or more individual re-planting units. Each of the individual replanting units may then be removed from the base unit 34 and positioned in a hole, planter, or other position in landscaping or gardening for growth of the plant to final maturity.

Testing has shown that when used on a deck, patio, or other nonporous surface; watering of the plants often results in excess water flowing through the fine screen mesh bag 74 and base unit 34 onto the deck, patio, or floor below the planter box 20. Thus, a removable and water retaining drip pan 84 may be provided for capture and/or diversion of excess water. The drip pan 84 may be attached to the base unit 34 above or below the bottom panel 44.

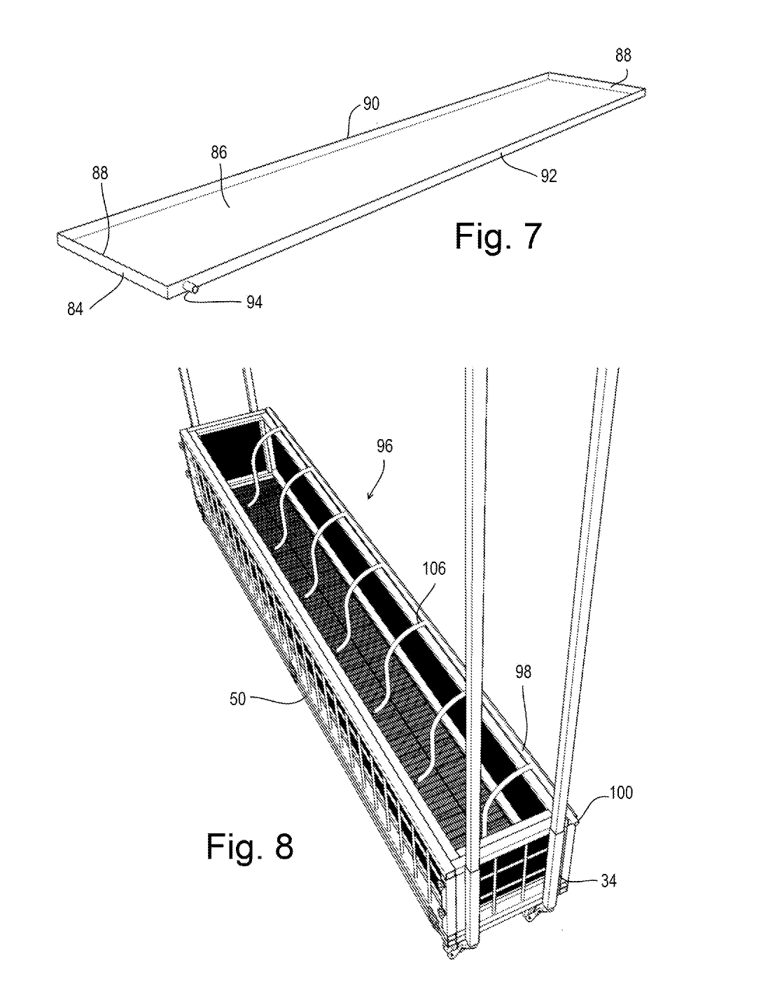

In the example shown in FIG. 7, the drip pan 84 comprises a base panel 86, side panels 88 a rear panel 90 and a front panel 92. An outflow connection 94 may be provided to allow diversion of the captured excess water by way of an attached hose or pipe away from the deck, patio, or floor. The outflow pipe 94 may be connected to a bucket or other apparatus to allow reuse of the water.

Looking to FIG. 12 is shown one example of the drip pan 84 having been longitudinally positioned on laterally opposed bottom supports 120. In the example shown, these bottom supports extend horizontally (laterally) from the trellis supports 24. The bottom supports 120 may be bent to form or attached to vertical extensions 122 forming sidewalls to planter box. These sidewalls 122 may extend the longitudinal length of the apparatus and support or replace the back panel 48 and/or front panel 50.

Bottom panel brackets 124 may also be attached to or formed with the sidewalls 122 and/or bottom support 120. In the example shown; the bottom panel 44 rests upon the bottom panel brackets 124. The fabric bag 38 may extend vertically above the sidewall 122.

The arrangement of the bottom supports etc. may be rotated 90° in a horizontal plane to allow insertion and removal of the drip pan 84 from the front or rear of the apparatus.

FIG. 12 also shows an alternate to the vertical positioning system for the base unit 34, trellis cross member 26, and watering system 96. In this embodiment, surfaces defining a plurality of holes 126 are provided in the trellis supports 24, and similar surfaces defining holes 128 are provided in the base unit 34, trellis cross member 26, or watering system 96. Pins 130 are then pressed through these holes, maintaining the base unit 34, trellis cross member 26, or watering system 96 at the desired vertical position.

A lighting system 132 may also be provided, attached to the trellis cross member 26 or equivalent. The lighting system provides heat and light to plants growing in the base unit 34.

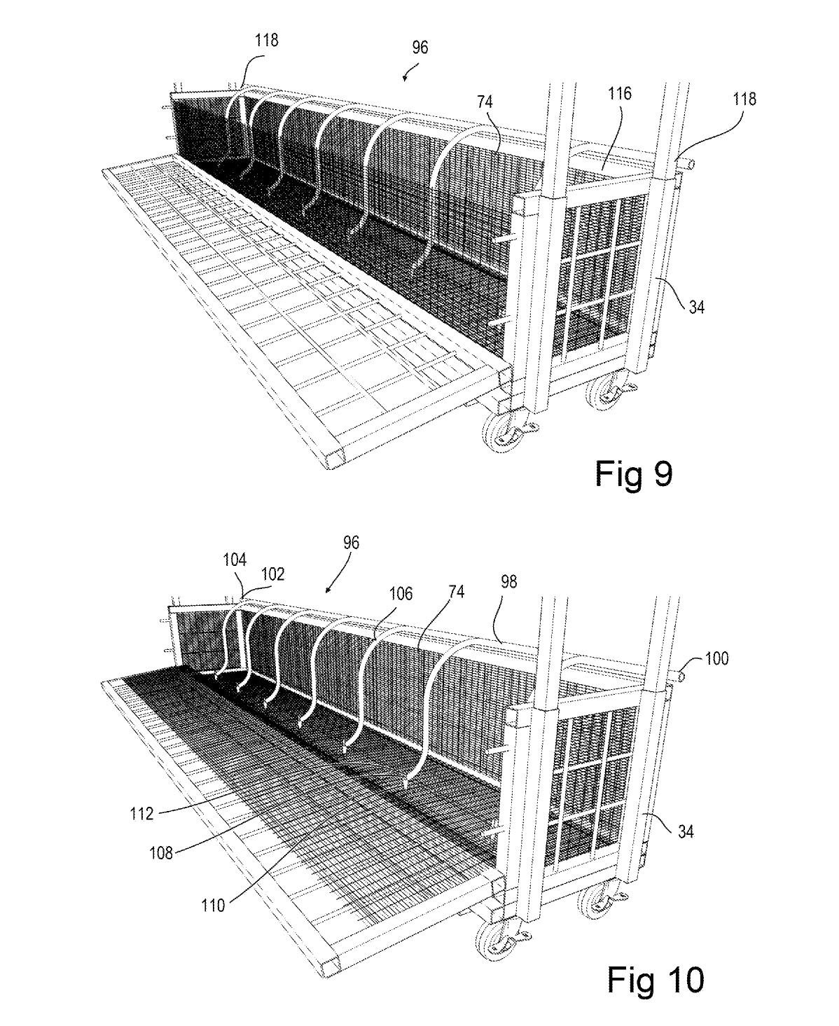

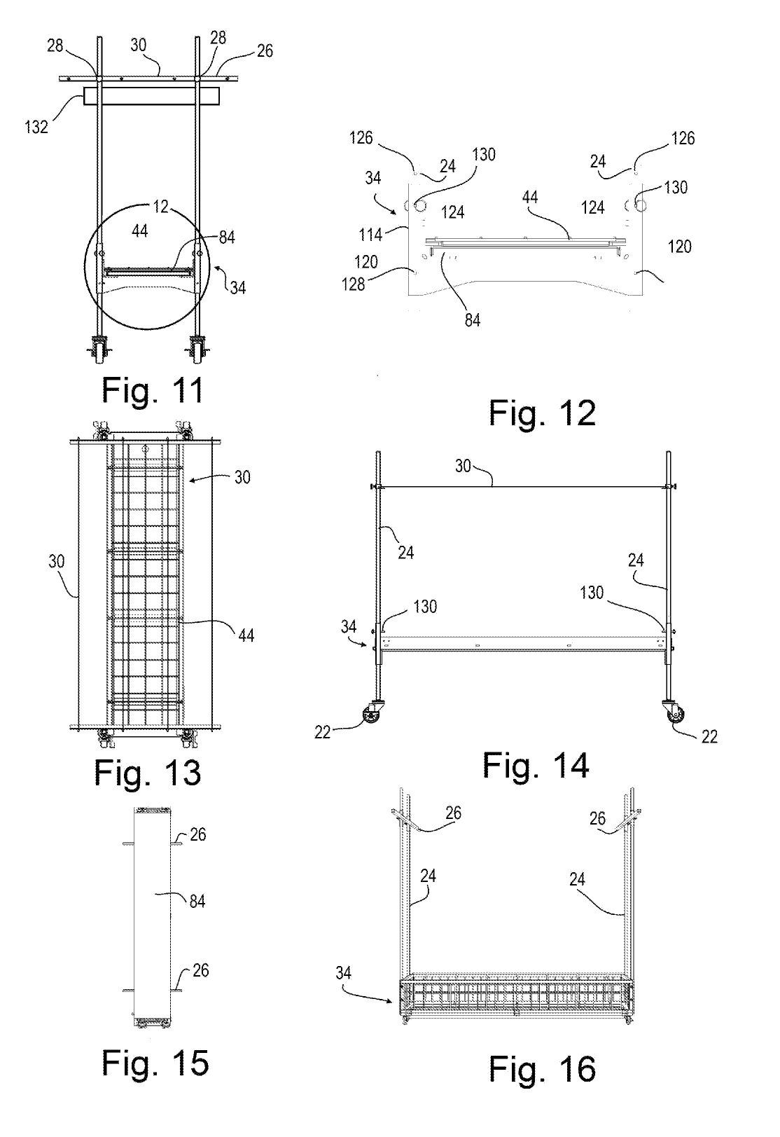

To facilitate watering of the plants within the apparatus, a watering system 96 is disclosed in FIGS. 8-10. Although the watering system 96 is shown positioned just above the upper edge 116 of the base unit 34, the watering system may alternatively be attached by way of a way of a watering system vertical adjustment system 118 functionally equivalent to the trellis adjuster 28. The watering system vertical adjustment system 118 allows for vertical repositioning of the trellis cross member 26 vertically along the trellis posts 24.

The watering system 96 of this example comprises a main line 98 attached to the base unit 34. The main line 98 of this example has at one end, a hose connection 100 for attachment to a garden hose or other water supply. The main line 98 may also comprise a second hose connection 102 having a (removable) cap 104 thereon. The second hose connection 102 may alternatively be connected to the main line 98 of the second planter box 20 or other apparatus. The main line 98 may have a plurality of orifices functioning as a sprinkler to spray, drip or otherwise provide water onto the plants and growing media within the fine screen mesh bag 74. The main line 98 in this example having a plurality of feed lines 106 attached to the main line 98. The feed lines 106 allow for selective placement of sprinkler heads 108. In one form a spike 110 (most easily seen in FIG. 10) is attached to the distal end of each feed line 106 to allow for selective placement of each sprinkler head 108 relative to the plants and or growing media. The spike 110 may be driven into the growing media at desired locations. In another example, the sprinkler heads 108 may be suspended well above the base unit 34. To facilitate independent use of the sprinkler heads 108, a valve 112 may be provided on each of the feed lines 106 between the main line 98 and the sprinkler head 108. As in several examples the sprinkler heads 108 may be positioned vertically below the main line 98, a check valve may also be utilized in the feed line 106. Such check valves have the benefit of reducing any siphon affects between the sprinkler head 108 and the main line 98.

While the present invention is illustrated by description of several embodiments and while the illustrative embodiments are described in detail, it is not the intention of the applicants to restrict or in any way limit the scope of the appended claims to such detail. For example the term trellis support indicates the vertical member as described, even if not uses as a trellis to support plants. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

1. A fabric mesh lined planter box comprising:
a. a base unit frame;
b. at least one wire mesh panel attached to the base unit frame forming a base unit;
c. a fabric mesh bag in contact with and vertically supported by the wire mesh panels;
d. the fabric mesh bag configured to contain growing media for growing of plants therein.

2. The planter box as recited in claim 1 further comprising a plurality of trellis posts removably attached to and extending vertically above the base unit.

3. The planter box as recited in claim 2 wherein the base unit is vertically positionable along the trellis posts.

4. The planter box as recited in claim 2 further comprising a trellis cross member attached to laterally adjacent trellis posts.

5. The planter box as recited in claim 1 further comprising a watering system comprising a main line attached to the base unit and having a hose connection thereon.

6. The planter box as recited in claim 5 further comprising:
a. a plurality of trellis posts removably attached to and extending vertically above the base unit;
b. the watering system is attached to the trellis posts via a vertical adjustment system providing vertical positioning of the watering system along the trellis posts.

7. The planter box as recited in claim 1 further comprising:
a. a water retaining drip pan removably attached to the base unit; and
b. the drip pan paced below the positioned below the fabric mesh bag for capture and/or re-diversion of water passing though the fabric mesh bag.
